(19) United States
(12) Patent Application Publication
(10) Pub. No.: US 2025/0263522 A1
(43) Pub. Date: Aug. 21, 2025

(54) IN-LINE PROCESSING OF POLYMER BEADS

(71) Applicant: Aspen Aerogels, Inc., Northborough, MA (US)

(72) Inventors: Arun Surendranath, Northborough, MA (US); Patrick Wang, Northborough, MA (US); Derek Li, Northborough, MA (US)

(21) Appl. No.: 19/196,173

(22) Filed: May 1, 2025

Related U.S. Application Data
(63) Continuation of application No. PCT/IB2023/061122, filed on Nov. 3, 2023.
(60) Provisional application No. 63/422,162, filed on Nov. 3, 2022.

(51) Int. Cl. C08J 3/075

(52) U.S. Cl. CPC C08J 3/075; C08J 2379/08

(57) ABSTRACT

The present disclosure is directed to methods of forming polymer beads in a continuous or in-line manner (i.e., not a batch manner). The methods generally include providing or forming a sol solution followed by gelation through addition of a gelation initiator. To form the beads, an oil phase or a sol-immiscible solvent, optionally in the presence of a surfactant is combined with the sol to create an emulsion. In general, one or more continuous processing parameters (e.g., mixing speed, pressure, recirculation, etc.) is controlled to form uniformly sized polymer beads. The polymer beads formed in the continuous process can then be transported to downstream manufacturing stations (e.g., carbonization stations, drying stations, etc.). Methods of the present technology are advantageous in that the methods can be incorporated into commercial scale production procedures and methods allowing for more efficient manufacturing of beads, aerogels, and products incorporating the polymer beads.

### CROSS REFERENCE TO RELATED APPLICATIONS

This application is a continuation of International Application No. PCT/IB2023/061122, filed Nov. 3, 2023, which claims priority to and the benefit of U.S. Provisional Patent Application No. 63/422,162, filed Nov. 3, 2022, both of which are herein incorporated by reference in their entireties.

### TECHNICAL FIELD

The present technology relates generally to an in-line or continuous formation process for producing polymer beads. In particular, the present technology relates to an in-line process for the production of polymer beads, such as for example polyimide beads, utilizing an organic-based sol, a solvent, optionally a surfactant, and a gelation initiator. The polymer beads formed through the continuous, in-line process of the present technology can be incorporated into products, such as aerogel blankets. The continuous in-line process for forming polymer beads can be incorporated into other manufacturing processes.

### BACKGROUND

Aerogels are solid materials that include a highly porous network of micro-, meso-, and macro-sized pores. Depending on precursor materials used and processing undertaken, the pores of an aerogel can frequently account for over 90% of the volume when the density of the aerogel is about 0.05 g/cc. Aerogels are generally prepared by removing the solvent from a gel (a solid network that contains a solvent) in a manner such that minimal or no contraction of the gel can be brought by capillary forces at its pore walls. Methods of solvent removal include, but are not limited to, supercritical drying (or drying using supercritical fluids, such that the low surface tension of the supercritical fluid replaces the high surface tension gelation solvent within the gel), exchange of solvent with supercritical fluid, exchange of solvent with fluid that is subsequently transformed to the supercritical state, sub- or near-critical drying, and sublimating a frozen solvent in a freeze-drying process. See for example, PCT Patent Application Publication No. WO2016127084A1. It should be noted that when drying in ambient conditions, gel contraction may take place with solvent evaporation, and a xerogel can form. Therefore, aerogel preparation through a sol-gel process or other polymerization processes typically proceeds in the following series of steps: dissolution of the solute in a solvent, addition of a catalyst or reagent that induces or promotes reaction of the solute, formation of a reaction mixture, formation of the gel (may involve additional heating or cooling), and solvent removal by a supercritical drying technique or any other method that removes solvent from the gel without causing contraction or pore collapse.

Aerogels can be formed of inorganic materials, organic materials, or mixtures thereof. When formed of organic materials such as, for example, phenols, resorcinol-formaldehyde (RF), phloroglucinol-furfuraldehyde (PF), polyacrylonitrile (PAN), polyimide (PI), polyurethane (PU), polyurea (PUA), polyamine (PA), polybutadiene, polydicyclopentadiene, and precursors or polymeric derivatives thereof, the organic aerogel may be carbonized (e.g., by pyrolysis) to form carbon aerogels, which can have properties (e.g., pore volume, pore size distribution, morphology, etc.) that differ from or overlap with each other, depending on the precursor materials and methodologies used.

To tailor properties of the aerogel, control of pore structure and morphology have been identified as key attributes. Using polymeric materials in bead form for the creation of aerogels may aid in solvent removal and definition of the resulting aerogel properties.

### SUMMARY

The present technology is generally directed to methods of forming polymer (e.g., polyimide) beads in a continuous in-line manner (i.e., not a batch manner). The methods generally comprise providing or forming a sol solution followed by gelatin of the sol through the addition of a gelation initiator. To form the beads, an oil phase or a sol immiscible solvent (optionally including a surfactant) is combined with the sol and immiscible solvent to create an emulsion. In conventional methods for forming beads, batch process manufacturing is used as there are numerous rate-limiting steps in forming beads. For example, due to the rate of reaction between the gelation initiator and the sol, batch processing has been used to control the combination of these elements (i.e., mixing speeds) so that uniformly sized beads can be produced in the emulsion. In this way, batch size and mixing speed can be controlled and accounted for. However, batch processes do not lend themselves to commercial production scale. Moreover, batch processes are limited in the amount of material created in a batch due to limitations in mixing and reaction rates.

Surprisingly, it has been found according to the present disclosure that uniform bead sizes could be produced through control of various processing parameters during a continuous (non-batch) method. For example, uniform beads were produced in a continuous method through controlling the timing of the addition of the gelation initiator (e.g., a dehydrating agent). The method is advantageous in providing rapid gelation, making the method amenable to configuration in a continuous process. Moreover, the continuous processing through using in-line methods allow for commercial scale production of the polymer beads. The polymer beads formed in a continuous process may be converted to aerogels as well as carbon aerogels in downstream processing steps. As a result, commercial scale production of products generated from the polymer beads is achievable.

The methods generally comprise forming an emulsion including a sol, a solvent immiscible with the sol, optionally a surfactant, and a gelation initiator in a continuous process in which one or more processing parameters (e.g., mixing speed, pressure, recirculation, etc.) is controlled to form uniformly sized polymeric beads. The sol and the solvent are immiscible materials, such that the emulsion is formed when the two immiscible materials are mixed. The gelation initiator causes gelling of the sol to occur, and beads are formed from the gelled portions of the emulsion. The present technology provides methods in which the sol, solvent, and gelation initiator are mixed in an on-line, continuous process. The polymeric beads formed in the continuous in-line process (i.e., not a batch process) can then be transported to downstream manufacturing stations (e.g., carbonization stations, drying stations, etc.). Methods of the present technology are advantageous in that the methods can be incorporated into commercial scale production procedures and methods allowing for more efficient manufacturing of beads, aerogels, and products incorporating the polymer beads.

Some examples of the present technology are directed to a continuous method of forming polyimide beads. In these methods, a polyamic acid salt is imidized. In general, the imidizing is performed chemically, e.g., in the presence of a gelation initiator which acts as a dehydrating agent. To form the beads, an oilphase (e.g., an immiscible solvent, optionally including a surfactant) is used to create an emulsion to generate the beads.

In an aspect, the technology is directed to a method for in-line manufacturing of an emulsion for polymer bead formation. The method includes: pumping with a first pump a sol (e.g., organic sol, such as a water-based sol) to an in-line mixer; pumping with a second pump an immiscible (e.g., organic or oil-based) solvent, optionally including a surfactant to the in-liner mixer; mixing the sol and the immiscible solvent to form an emulsion; providing a gelation initiator to a mixing system downstream of the first pump and the second pump to disperse the gelation initiator throughout the emulsion; and transporting the emulsion with gelation initiator to a processing station located downstream of the mixing system. Examples of processing stations include, but are not limited to, reservoirs, drying stations, heat treatment stations, carbonizing stations, and particle sorting stations.

Examples of the above aspect may include one or more of the following features. In some examples, the mixing system comprises the in-line mixer and a reservoir. The reservoir can be located downstream of the in-line mixer. The gelation initiator can be provided to the reservoir. Examples including the downstream reservoir can further feature a recirculation loop positioned between the reservoir and the in-line mixer. Some examples also include a controller and particle size sensor in connection with the recirculation loop for controlling the number of recirculation passes between the reservoir and the in-line mixer. In some examples, the gelation initiator is provided to the in-line mixer. That is, the gelation initiator is added prior to creation of an emulsion. Some examples include a second mixer downstream from the in-line mixer. The second mixer can be used for distributing the gelation initiator throughout a reservoir or for controlling bead particle size.

In some examples, the immiscible solvent used in the method is an organic (e.g., oil or oil-based) solvent, such as, for example, a C5-C12 hydrocarbon (e.g., mineral spirits), silicon oil, mineral oil, or kerosene. In some examples, the sol is a water-based sol. In certain examples, the immiscible solvent is mineral spirits and is pumped to the in-line mixer at a flow rate of 2:1 as compared to the water-based sol. In some examples, the water-based sol comprises a polyamic acid salt and water. In certain examples, the water-base sol comprises a polyamic acid, water, and a base (e.g., an alkali metal hydroxide or carbonate, a trialkylamine, or the like), forming a polyamic acid salt sol.

In some examples, the method further comprises controlling pressure during the step of mixing the water-based sol and the immiscible solvent to form the emulsion. The pressure is controlled to create a predetermine residence time in the in-line mixer for particle size selection. In some examples, a back pressure regulator is positioned between the in-line mixer and the processing station for controlling the pressure. In certain examples, the gelation initiator can be added to the reservoir. In other examples, the gelation initiator can be added to the in-line mixer.

In some examples, the in-line mixer comprises a two-pass mixer head. In certain embodiments, the in-line mixer comprises a four-pass mixer head.

In another aspect, the present disclosure is directed to a method for in-line manufacturing of an emulsion for polymer bead formation. The method comprises: pumping with a first pump a sol (e.g., water-based sol) to an in-line mixer; pumping with a second pump an immiscible solvent (e.g., mineral oil), optionally including a surfactant, to the in-line mixer; providing a gelation initiator for the sol to the in-line mixer; mixing the sol, the solvent and the gelation initiator in the in-line mixer to form an emulsion with gelation initiator disperse therethrough; and transporting the emulsion with gelation initiator dispersed therethrough to a downstream processing station.

Examples of the above aspect can feature one or more of the following. In some examples, the method further includes controlling pressure during mixing the sol, the immiscible solvent, and the gelation initiator to create a predetermined residence time in the in-line mixer. The predetermined residence time is selected to control particle size. In examples, a back pressure regulator is positioned between the in-line mixer and the downstream processing station. In some examples, the solvent is organic (e.g., an oil or oil-based) solvent, such as, for example mineral spirits. The sol and solvent are selected to create two distinct phases that when mixed can form an emulsion. For example, in an example, the sol is a water-based sol and the immiscible solvent is an oil-based solvent. In some examples, in which mineral spirits are used as the immiscible solvent, the mineral spirit is pumped to the in-line mixer at a flow rate of 2:1 as compared to the water-based sol. In other examples, the sol is organic solvent-based, and the emulsion is formed with a solvent (e.g., water) which is immiscible with the organic solvent sol.

In some examples, the first and second pumps are peristaltic pumps. The peristaltic pumps deliver the water-based sol and the immiscible solvent to the in-line mixer for formation of the emulsion.

Some examples feature an addition step of controlling viscosity of the emulsion with gelation initiator dispersed therethrough. In certain examples controlling the viscosity includes selection of the gelation initiator. In some examples, controlling the viscosity includes selection of the sol. In some examples, controlling the viscosity includes selection of the solvent, the surfactant, or both. In some examples, controlling the viscosity includes controlling the flow rate of a selected sol to a selected solvent.

Some examples feature an addition step of adjusting a mixing speed of the in-line mixer. Certain examples feature the step of adjusting the back pressure regulator to control bead particle size.

According to another aspect, the present disclosure is directed to a method for continuous processing of an emulsion-based polymer product. The method includes: delivering to an in-line mixer a solvent, optionally including a surfactant through a pumping system; delivering to the in-line mixer a mixed fluid including a sol pumped using a dedicated first pump and a gelation initiator solution pumped using a dedicated second pump; mixing the mixed fluid together with the solvent in the in-line mixer to form an emulsion; and transporting the emulsion to a downstream processing station.

Examples of the above aspect can include one or more of the following features. In some examples, the in-line mixer includes a two-pass mixer head. In certain examples, the in-line mixer includes a four-pass mixer head. In some examples, the method further comprises controlling the pressure during mixing the mixed fluid together with the solvent in the in-line mixer to create a predetermined residence time in the in-line mixer for control over particle size. Some examples feature a back pressure regulator positioned between the in-line mixer and the downstream processing station. In certain examples, the back pressure regulator is adjusted to control particle size. Some examples further comprise controlling viscosity of the emulsion. In certain examples, controlling the viscosity includes controlling sol density. Without wishing to be bound by theory, it is believed that a higher density of the sol tends to give higher viscosity, which translates to longer molecular weight of the polyamic acid. An increase in viscosity impacts particle size, if all other conditions are maintained (e.g., same flow rates and shear rates for mixing). In certain examples, the flow rates can be adjusted with respect to viscosity to address particle size. Some examples of the present disclosure further include adjusting a mixing speed of the in-line mixer. The pumping system used in the present disclosure can comprise a peristaltic pump. In some examples, the dedicated first and second pumps are peristaltic pumps. The immiscible solvent used in the method can be an oil or oil-based solvent, such as, for example mineral spirits. The sol can be a water-based sol that is immiscible with the oil or oil-based solvent. In some examples, the solvent is mineral spirits, the sol is a water-based sol, and pumping of the mineral spirits to the in-line mixer occurs at a flow rate of 2:1 as compared to the mixed fluid.

Examples of the above aspect can further include recirculating the emulsion via a recirculation loop through the in-line mixer prior to transporting the emulsion to the downstream processing station(s). The recirculation loop can include a controller and a particle size sensor for controlling the number of recirculation passes through the in-line mixer prior to transporting the emulsion to the downstream processing station.

In some examples, the emulsion comprises a surfactant. In some examples, the surfactant is added to the immiscible solvent to form a solution. In some examples, the surfactant is non-ionic. In some examples, the non-ionic surfactant comprises a polyethylene glycol ester of a fatty acid, a propylene glycol ester of a fatty acids, a polysorbate, a polyglycerol ester of a fatty acid, a sorbitan ester of a fatty acid, a polyoxyethylene-sorbitan-fatty acid ester, a polyoxyethylene fatty acid ester, a polyoxyethylene ether, a polyoxyethylene castor oil derivative, a polyoxyethylene-polyoxypropylene co-polymer, a monoglyceride, an acetylated monoglyceride, a polymeric polyester-polyol surfactant, or a combination thereof. In some examples, the non-ionic surfactant is Hypermer® A70.

The above aspects of the present disclosure can be used to form polymer beads. In some examples, the polymer beads are polyimide beads. In some examples the polyimide beads are formed using a water-based sol in the continuous process to form the beads. The water-based sol is general formed by: providing a polyamic acid; adding the polyamic acid to water to form an aqueous suspension of the polyamic acid; and adding a base to the aqueous suspension of the polyamic acid to form the aqueous solution of the polyamic acid salt.

In some examples, the base is an alkali metal hydroxide, carbonate, or bicarbonate. In some examples, the alkali metal hydroxide is lithium hydroxide, sodium hydroxide, or potassium hydroxide. In some examples, the base is a trialkylamine, such as triethylamine. In some examples, the base is an alkali metal carbonate or bicarbonate. In some examples, the base is guanidium carbonate or bicarbonate.

In some examples, the polyamic acid comprises a tetracarboxylic acid selected from the group consisting of benzene-1,2,4,5-tetracarboxylic acid, [1,1′-biphenyl]-3,3′,4,4′-tetracarboxylic acid, 4,4′-oxydiphthalic acid, 4,4′-sulfonyldiphthalic acid, 4,4′-carbonyldiphthalic acid, 4,4′-(propane-2,2-diyl)diphthalic acid, 4,4′-(perfluoropropane-2,2-diyl)diphthalic acid, naphthalene-1,4,5,8-tetracarboxylic acid, 4-(2-(4-(3,4-dicarboxyphenoxy)phenyl) propan-2-yl) phthalic acid, perylene tetracarboxylic acid, and combinations thereof.

In some examples, the polyamic acid comprises a C2-C6 alkylene diamine, wherein one or more of the carbon atoms of the C2-C6 alkylene is optionally substituted with one or more alkyl groups. In some examples, the C2-C6 alkylene diamine is selected from the group consisting of ethylenediamine, 1,3-diaminopropane, 1,4-diaminobutane, 1,5-diaminopentane, 1,6-diaminohexane, or a combination thereof.

In some examples, the polyamic acid comprises an arylene diamine. In some examples, the polyamic acid comprises 1,3-phenylenediamine, 1,4-phenylenediamine, 4,4′-methylenedianiline, 4,4′-diaminodiphenyl ether, or a combination thereof. In some examples, the polyamic acid comprises a diamine selected from the group consisting of 1,4-phenylenediamine, 4,4′-methylenedianiline, 4,4′-diaminodiphenyl ether, and combinations thereof.

In some examples, a range of concentration of the polyamic acid salt in the solution is from about 0.01 to about 0.3 g/cm³, based on the weight of the polyamic acid.

In examples where the polymer beads are polyimide beads, the method comprises imidizing the polyamic acid salt with the gelation initiator (i.e., the gelation initiator is a chemical imidizing agent). In some examples, the chemical imidizing agent is a dehydrating agent. In some examples, the dehydrating agent (i.e., the gelation initiator) is acetic anhydride.

The above aspects of the present disclosure are directed to methods of forming polymer beads in a continuous process. The present disclosure can be used to produce materials in large-scale quantities. In addition, the methods of the present disclosure can be used to process materials in multiple steps in a continuous fashion. For example, the polymer beads formed in continuous process can be transported downstream for continued processing steps, such as drying (e.g., drying to create an aerogel), pyrolyzing or heating (e.g., carbonizing of the polymer bead); bead sorting (e.g., sorting beads by size or morphology), combining polymer beads or processed polymer beads with other materials to form additional products (e.g., forming a sheet or blanket incorporating beads). Further advantages of the present disclosure include continuous formation of bead material. For example, in batch processes, each batch size is limited by the constraints of the mixer size for combining the precursor constituents. That is, the precursors are added and mixed to form the batch. As the catalyst starts the gelling process, the amounts of sol, solvent, and gelation initiator that can be combined and mixed are constrained. Processing of just a batch at a time is discontinuous and leads to inefficiencies in production.

### BRIEF DESCRIPTION OF THE DRAWINGS

In order to provide an understanding of embodiments of the technology, reference is made to the appended drawings, which are not necessarily drawn to scale. The drawings are exemplary only and should not be construed as limiting the technology. The disclosure described herein is illustrated by way of example and not by way of limitation in the accompanying figures.

FIG. 1 is flow chart depicting a process for preparing polyimide aerogel microbeads using an emulsion.

FIG. 2 is a flow chart depicting another process for preparing polyimide aerogel microbeads using an emulsion.

FIG. 3 is a schematic depicting a first method of forming polymer beads from an emulsion.

FIG. 4 is a schematic depicting a second method of forming polymer beads from an emulsion.

FIG. 5 is a schematic of a continuous processing system used for forming polymer beads according to an example of the present technology.

FIG. 6 is a schematic of a continuous processing system used for forming polymer beads according to another example of the present technology.

FIG. 7 is an illustration of a mixing head used to mix components delivered to an in-line mixer according to an example of the present technology.

FIG. 8A is an illustration of a two-pass mixing head used to mix components delivered to an in-line mixer according to another example of the present technology.

FIG. 8B is an illustration of a four-pass mixing head used to mix components delivered to an in-line mixer according to another example of the present technology.

FIG. 9 is a schematic of a continuous processing system used for forming polymer beads according to another example of the present technology.

FIG. 10 is a schematic of a continuous processing system used for forming polymer beads according to another example of the present technology.

FIG. 11 is a graphical representation of particle size at different time/steps during the continuous mixing process for particle beads formed in Example 1.

FIG. 12A is a SEM image of particles after recirculation in accordance with Example 1.

FIG. 12B is a SEM image of particles after imidization in accordance with Example 1.

FIG. 13 is a graphical representation of particle size at different time/steps during the continuous mixing process for particle beads formed in Example 2.

FIG. 14A is a SEM image of particles after recirculation in accordance with Example 2.

FIG. 14B is a SEM image of particles after imidization in accordance with Example 2.

FIG. 15 is a graphical representation of particle size at different time/steps during the continuous mixing process for particle beads formed in Example 3.

FIG. 16A is a SEM image of particles after recirculation in accordance with Example 3.

FIG. 16B is a SEM image of particles after imidization in accordance with Example 3.

FIG. 17 is a graphical representation of particle size at different time/steps during the continuous mixing process for particle beads formed in Example 4.

FIG. 18A is a SEM image of particles after emulsification in accordance with Example 4.

FIG. 18B is a SEM image of particles after imidization in accordance with Example 4.

FIG. 19 is a graphical representation of particle size at different time/steps during the continuous mixing process for particle beads formed in Example 5.

FIG. 20A is a SEM image of particles after emulsification in accordance with Example 5.

FIG. 20B is a SEM image of particles after imidization in accordance with Example 5.

FIG. 21 is a graphical representation of particle size at different time/steps during the continuous mixing process for particle beads formed in Example 6.

FIG. 22A is an SEM image of particles after emulsification in accordance with Example 6.

FIG. 22B is a SEM image of particles after imidization in accordance with Example 6.

FIGS. 23A-23D provide SEM images showing particle morphology for an aerogel made in a batch process.

FIGS. 24A-24D provide SEM images showing particle morphology for an aerogel made in a continuous method in accordance with the present technology.

### DETAILED DESCRIPTION

Before describing several examples of the technology, it is to be understood that the technology is not limited to the details of construction or process steps set forth in the following description. The technology is capable of other embodiments and of being practiced or being carried out in various ways.

In general, the technology is directed to continuous or in-line processing methods for producing polymer beads. The technology provides a non-batch processing route for the formation of polymer beads. This method is advantageous, as compared to batch methods, not only due to its ability to provide commercial-scale production of the beads themselves, but also for its applicability to incorporate downstream processing steps after bead formation. In this way, the production of products incorporating the beads or processing of beads (e.g., carbonization) can be scaled for commercial production.

Surprisingly, it was found according to the present disclosure that uniform bead sizes could be produced through control of various processing parameters during a continuous (non-batch) method. For example, uniform beads were produced in a continuous method through controlling the timing of the addition of the gelation initiator (dehydrating agent). The method is advantageous in providing rapid gelation, making the method amenable to configuration in a continuous process. In some examples, uniform beads were produced by controlling viscosity of a created emulsion. In certain examples, uniform beads were produced by controlling pressure within a mixing head. In some examples, uniform beads were produced by controlling residence time within the mixer head. Further, it was found that tailoring of the bead size and distribution of bead sizes could be influenced by controlling one or more of the above processing factors.

The methods of the present technology generally comprise forming an emulsion including a sol, a solvent immiscible with the sol, optionally a surfactant, and a gelation initiator in a continuous process in which one or more processing parameters (e.g., mixing speed, pressure, recirculation, etc.) is controlled to form uniformly sized polymeric beads. The sol and solvent are immiscible with each other. As a result, when the sol and solvent are mixed together, optionally in the presence of a surfactant (e.g., a solution of surfactant in the immiscible solvent), an emulsion can be generated. Polymeric beads are formed in the emulsion by the gelation of the sol via the gelation initiator. The present technology is directed to methods in which the sol, solvent and the gelation initiator are mixed in a continuous process. The polymeric beads formed in the continuous in-line process (i.e., not a batch process) can then be transported to downstream manufacturing stations (e.g., carbonization stations, drying stations, etc.). Methods of the present technology are advantageous in that the methods can be incorporated into commercial scale production procedures and methods allowing for more efficient manufacturing of beads, aerogels, and products incorporating the polymer beads.

In some instances, the polymer beads formed using the present technology are further processed in downstream steps. For example, the beads can be aged, washed and dried to create aerogel or beads. In addition, or alternatively, the beads can be thermally treated. For example, heat can be applied to the bead (prior to or after creation of the aerogel) to carbonize the beads or in some instances to modify microstructures within the beads. In the present application, reference will be made to creation of polyimide beads in a continuous method. It should be recognized to those of ordinary skill in the art that the methods of the present technology are applicable to the creation of other types of polymer beads. That is, the technology is not limited to the continuous formation of polyimide beads. Moreover, the technology is not limited by the types of sol, solvent, surfactant, and gelation initiator used. In the methods discussed below with respect to polyimide beads, the sol is a water-based sol and the solvent is organic (e.g., oil-based). However, the method disclosed is also applicable to organic solvent-based sols in which the immiscible solvent is aqueous.

### Definitions

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 angstroms. However, framework structures of the present disclosure can also include networks of interconnected oligomers, polymers, or colloidal particles of all diameter sizes that form the solid structure within in a gel or aerogel.

As used herein, the term “aerogel” refers to a solid object, irrespective of shape or size, comprising a framework of interconnected solid structures, with a corresponding network of interconnected pores integrated within the framework, and containing gases such as air as a dispersed interstitial medium. As such, and irrespective of the drying method used, aerogels are open non-fluid colloidal or polymer networks that are expanded throughout their whole volume by a gas and are formed by the removal of all swelling agents from a corresponding wet-gel. Reference to an “aerogel” herein includes any open-celled porous materials which can be categorized as aerogels, xerogels, cryogels, ambigels, microporous materials, and the like, regardless of material (e.g., polyimide, polyamic acid, or carbon), unless otherwise stated.

Generally, aerogels possess one or more of the following physical and structural properties: (a) an average pore diameter ranging from about 2 nm to about 100 nm; (b) a porosity of about 60% or more; (c) a specific surface area of about 0 to about 100 m²/g or more, typically from about 0 to about 20, about 0 to about 100, or from about 100 to about 1000 m²/g. Typically, such properties are determined using nitrogen porosimetry testing and/or helium pycnometry. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite.

In some examples, a gel material may be referred to specifically as a xerogel. As used herein, the term “xerogel” refers to a type of aerogel comprising an open, non-fluid colloidal or polymer networks that is formed by the removal of all swelling agents from a corresponding gel without any precautions taken to avoid substantial volume reduction or to retard compaction. A xerogel generally comprises a compact structure. Xerogels suffer substantial volume reduction during ambient pressure drying, and generally have surface areas of 0-100 m²/g, such as from about 0 to about 20 m²/g as measured by nitrogen sorption analysis.

As used herein, the term “gelation” or “gel transition” refers to the formation of a wet-gel from a polymer system, e.g., a polyimide or polyamic acid as described herein. At a point in the polymerization or dehydration reactions as described herein, which is defined as the ‘gel point,’ the sol loses fluidity. Without intending to be bound to any particular theory, the gel point may be viewed as the point where the gelling solution exhibits resistance to flow. In the present context, gelation proceeds from an initial sol state (e.g., a solution of an ammonium salt of a polyamic acid), through a highly viscous disperse state, until the disperse state solidifies and the sol gels (the gel point), yielding a wet-gel (e.g., polyimide or polyamic acid gel). The amount of time it takes for the polymer (e.g., ammonium salt of a polyamic acid or a polyimide) in solution to transform into a gel in a form that can no longer flow is referred to as the ‘phenomenological gelation time.’ Formally, gelation time is measured using rheology. At the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G” Crossover? “Polym. Eng. Sci., 1987, 27, 1698-1702; S.-Y. Kim, D.-G. Choi and S.-M. Yang ‘Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658.

As used herein, the term ‘wet-gel’ refers to a gel in which the mobile interstitial phase within the network of interconnected pores is primarily comprised of a liquid phase such as a conventional solvent or water, liquefied gases such as liquid carbon dioxide, or a combination thereof. Aerogels typically require the initial production of a wet-gel, followed by processing and extraction to replace the mobile interstitial liquid phase in the gel with air or another gas. Examples of wet-gels include, but are not limited to: alcogels, hydrogels, ketogels, carbonogels, and any other wet-gels known to those in the art.

The term “substantially” as used herein, unless otherwise indicated, means to a great extent, for example, greater than about 95%, greater than about 99%, greater than about 99.9%, greater than 99.99%, or even 100% of a referenced characteristic, quantity, etc. as pertains to the particular context (e.g., substantially pure, substantially the same, and the like).

### Methods of Forming Polyimide Aerogel Beads by Emulsification

In some examples, the disclosed method forms polyimide beads. The method utilizes an emulsion to form the polyimide beads as a wet-gel, followed by converting the wet-gel beads to aerogel beads. The emulsion is formed via a continuous process in which a polyamic acid sol, a solvent (which is immiscible with the sol) and a gelation initiator are combined in a continuous fashion to create the emulsion. As pockets of sol within the emulsion gel, beads are formed. The beads can then be processed downstream of an in-line mixer used to create the emulsion. Downstream process stations can include bead drying stations, such as supercritical drying stations to create polyimide aerogel beads.

### Aqueous Polyamic Acid Sol

To form polyimide beads, an aqueous processing route can be utilized. The aqueous processing route utilizes an aqueous or water-based sol. There are many different methods or routes for providing a water-based sol for the creation of a polyimide gel bead. These methods or routes all share the common feature of providing an aqueous solution of a polyamic acid salt. Such solutions may be obtained by dissolving a pre-formed polyamic acid in water in the presence of a base, or may be obtained by in situ preparation from polyamic acid precursors (diamine and tetracarboxylic dianhydride) under aqueous conditions in the presence of a base. The salt of the polyamic acid may be an alkali metal salt or an ammonium salt. In some examples, the salt is an ammonium salt, such as a trialkylammonium salt (e.g., triethylammonium). In some examples, the salt is a guanidinium salt. In some examples, the salt is a sodium or potassium salt. Information on these methods and routes can be found in U.S. Patent Application Publication No. 2022/0185970, filed on Dec. 9, 2021, and incorporated herein by reference in its entirety. Some of the permutations provided in US2022/0185970 relate to forming polyimide beads in an emulsion format. Those processing routes can be utilized in the present technology and are provided below as an example of the sol, solvent, surfactant, and dehydrating agent combination for formation of an emulsion and formation of an aerogel. Discussion of the components of a system for continuous processing to form the emulsion are described further herein below.

As a general, non-limiting description of the disclosed methods of forming a polyimide bead in an emulsion format, a polyamic acid sol, an immiscible solvent, and optionally a surfactant are combined and an emulsion formed under high shear conditions. Either before or after formation of the emulsion, a gelation initiator (i.e., a chemical imidizing agent, for example, a dehydrating agent such as acetic anhydride) is added, causing the sol to gel and form polyimide beads. The two major permutations of the method relate to when the gelation initiator is added. These two permutations are described below. While directed to polyimide bead formation, the disclosure is not intended to be limited to formation of polyimide beads. Other polymer-based beads may be formed using alternative sols (e.g., other polymer precursors) and gelation initiators, such alternative materials are contemplated herein, and one of skill in the art would understand how to apply the disclosed methods to preparation of such alternative polymer beads.

### Emulsion Method 1: Sequentially Forming Emulsion and Imidizing

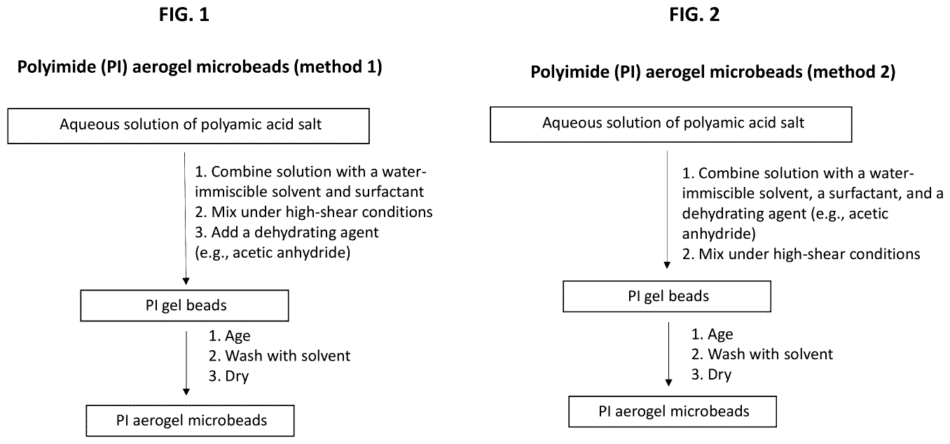

In some examples, the method comprises forming an emulsion comprising the polyamic acid salt sol (prepared as described above), immiscible solvent, and a surfactant, and mixing under high-shear conditions. This general non-limiting approach is illustrated in in FIG. 1. With reference to FIG. 1, forming the gel beads comprises combining an aqueous solution of a polyamic acid salt with a water-immiscible solvent and a surfactant and mixing under high-shear conditions.

The water-immiscible solvent may vary. Suitable solvents include, but are not limited to, oils such as silicone oil or mineral oil, aliphatic hydrocarbons, aromatic hydrocarbons, and chlorinated hydrocarbons. In some examples, the solvent is a C5-C12 aliphatic or aromatic hydrocarbon. In some examples, the solvent is hexane. In particular examples, the solvent is mineral spirits.

To aid in the formation and stabilization of emulsions by promoting dispersion of hydrophobic and hydrophilic (e.g., oil and water) components, an emulsifying agent can be incorporated into the sol-immiscible solvent. Such emulsifying agents include emulsifiers, surfactants, stabilizers, and combination thereof. In some examples, the emulsifying agent is a surfactant. Suitable surfactants are generally non-ionic, and include, but are not limited to, polyethylene glycol esters of fatty acids, propylene glycol esters of fatty acids, polysorbates, polyglycerol esters of fatty acids, sorbitan esters of fatty acid, and the like. Suitable surfactants have an HLB number ranging from about 0 to about 20. In some examples, the HLB number is from about 3.5 to about 6. As will be understood by one skilled in the art, HLB is the hydrophilic-lipophilic balance of an emulsifying additive, which is a measure of the degree to which it is hydrophilic or lipophilic. The HLB value may be determined by calculating values for the different regions of the molecule, as described by Griffin in Griffin, William C. (1949), “‘Classification of Surface-Active Agents by ‘HLB’’” (PDF), Journal of the Society of Cosmetic Chemists, 1 (5): 311-26 and Griffin, William C. (1954), “Calculation of HLB Values of Non-Ionic Surfactants” (PDF), Journal of the Society of Cosmetic Chemists, 5 (4): 249-56, and by Davies in Davies JT (1957), “A quantitative kinetic theory of emulsion type, I. Physical chemistry of the emulsifying agent” (PDF), Gas/Liquid and Liquid/Liquid Interface, Proceedings of the International Congress of Surface Activity, pp. 426-38. HLB value may be determined in accordance with the industry standard textbook, namely “The HLB SYSTEM, a time-saving guide to emulsifier selection” ICI Americas Inc., Published 1976 and Revised, March 1980.

Examples of suitable surfactants generally include, but are not limited to: polyoxyethylene-sorbitan-fatty acid esters; e.g., mono- and tri-lauryl, palmityl, stearyl and oleyl esters; e.g., products of the type known as polysorbates and commercially available under the trade name Tween® polyoxyethylene fatty acid esters, e.g., polyoxyethylene stearic acid esters of the type known and commercially available under the trade name Myrj®; polyoxyethylene ethers, such as those available under the trade name Brij®; polyoxyethylene castor oil derivatives, e.g., products of the type known and commercially available as Cremophors®, sorbitan fatty acid esters, such as the type known and commercially available under the name Span® (e.g., Span 80); polyoxyethylene-polyoxypropylene co-polymers, e.g., products of the type known and commercially available as Pluronic® or Poloxamer®; glycerol triacetate; and monoglycerides and acetylated monoglycerides, e.g., glycerol monodicocoate (Imwitor® 928), glycerol monocaprylate (Imwitor® 308), and mono- and di-acetylated monoglycerides. In some embodiments, the one or surfactants comprise a commercially available polymeric polyester-polyol surfactant of the type known under the trade name Hypermer® (Croda Industrial Chemicals; Edison, NJ, USA).

In some examples, the surfactant comprises Tween 20, Tween 80, Span 20, Span 40, Span 60, Span 80, or a combination thereof. In some examples, the surfactant is Span 20, Tween 80, or a mixture thereof. In some examples, the surfactants is Hypermer® B246SF. In some examples, the surfactants is Hypermer® A70.

The concentration of the surfactant may vary. In some examples, the surfactant, or a mixture of surfactants, is present in the mixture of emulsion components in an amount by weight from about 1 to about 5%, such as about 1, about 2, about 3, about 4, or about 5%, based on the total weight of the mixture of emulsion components.

Mixing the emulsion components under high-shear conditions generally provides micron-sized polyimide beads. Spherical droplets of the aqueous sol form in the sol-immiscible solvent by virtue of the interface tension. The droplets gel and strengthen during the time in the water-immiscible solvent, e.g., mineral spirits. Agitation of the mixture is typically used to form an emulsion and/or to prevent the droplets from agglomerating. For example, the mixture of aqueous gelation mixture (sol) and water-immiscible solvent can be agitated (e.g., stirred) to form an emulsion, which may be stable or temporary. Fluid undergoes shear when one area of fluid travels at a different velocity relative to an adjacent area. A high-shear mixer (homogenizer) uses a rotating impeller or high-speed rotor, or a series of such impellers or in-line rotors, to “work” the fluid, creating flow and shear. The tip velocity (i.e., the speed encountered by the fluid at the outside diameter of the rotor), will be higher than the velocity encountered at the center of the rotor, with this velocity difference creating shear. Generally, higher shear results in smaller beads.

With continued reference to FIG. 1, a gelation initiator which is a dehydrating agent is added to the emulsion, initiating gelation and forming polyimide gel beads. Various dehydrating agents can be used. The structure of the dehydrating agent may vary, but is generally a reagent that is at least partially soluble in the reaction solution, reactive with the carboxylate groups of the polyamic acid salt, and effective in driving the imidization of the polyamic acid carboxyl and amide groups, while having minimal reactivity with the aqueous solution. One example of a class of suitable dehydrating agents is the carboxylic acid anhydrides, such as acetic anhydride, propionic anhydride, and the like. In some examples, the dehydrating agent is acetic anhydride.

With continued reference to FIG. 1, following the formation of the polyimide gel beads, in order to form an aerogel structure within the beads, the polyimide gel beads are aged, washed (solvent exchanged), and dried in additional processing steps (i.e., occurring downstream of bead formation).

The process of transitioning a bead formed of a wet-gel material into an aerogel can include an aging step (also referred to as curing) prior to drying. Aging a wet-gel material after it reaches its gel point can further strengthen the gel framework. For example, in some examples, the framework may be strengthened during aging. The duration of gel aging can be adjusted to control various properties within the corresponding aerogel material. This aging procedure can be useful in preventing potential volume loss and shrinkage during liquid phase extraction of the wet-gel material. Aging can involve: maintaining the gel (prior to extraction) at a quiescent state for an extended period; maintaining the gel at elevated temperatures; or any combination thereof. The preferred temperatures for aging are usually between about 10° C. and about 200° C. Aging may also take place during solvent exchange, as described herein below. The aging of a wet-gel material may also be referred to as “curing,” and typically continues up to the liquid phase extraction of the wet-gel material.

With further reference to FIG. 1, following any aging, the resulting wet-gel material, may be washed or solvent exchanged in a suitable secondary solvent to replace the primary reaction solvent (i.e., water and/or immiscible solvent such as mineral spirits) present in the wet-gel. Such secondary solvents may be linear alcohols with 1 or more aliphatic carbon atoms, diols with 2 or more carbon atoms, or branched alcohols, cyclic alcohols, alicyclic alcohols, aromatic alcohols, polyols, ethers, ketones, cyclic ethers or their derivatives. In some examples, the secondary solvent is water, a C1 to C3 alcohol (e.g., methanol, ethanol, propanol, isopropanol), acetone, tetrahydrofuran, ethyl acetate, acetonitrile, supercritical fluid carbon dioxide (CO₂), or a combination thereof. In some examples, the secondary solvent is ethanol.

Once the wet-gel beads have been formed and processed, the liquid phase of the wet-gel beads can then be at least partially extracted from the wet-gel material using extraction methods, including processing and extraction techniques, to form an aerogel material (i.e., “drying”). Liquid phase extraction, among other factors, plays an important role in engineering the characteristics of aerogels, such as porosity and density, as well as related properties such as thermal conductivity. Generally, aerogels are obtained when a liquid phase is extracted from a wet-gel in a manner that causes low shrinkage to the porous network and framework of the wet-gel. Wet-gels can be dried using various techniques to provide aerogels or xerogels. In exemplary examples, wet-gel materials can be dried at ambient pressure, under vacuum (e.g., through freeze drying), at subcritical conditions, or at supercritical conditions to form the corresponding dry gel (e.g., an aerogel, such as a xerogel).

In some examples, it may be desirable to fine tune the surface area of the dry gel. If fine tuning of the surface area is desired, aerogels can be converted completely or partially to xerogels with various porosities. The high surface area of aerogels can be reduced by forcing some of the pores to collapse. This can be done, for example, by immersing the aerogels for a certain time in solvents such as ethanol or acetone or by exposing them to solvent vapor. The solvents are subsequently removed by drying at ambient pressure.

Aerogels are commonly formed by removing the liquid mobile phase from the wet-gel material at a temperature and pressure near or above the critical point of the liquid mobile phase. Once the critical point is reached (near critical) or surpassed (supercritical; i.e., pressure and temperature of the system is at or higher than the critical pressure and critical temperature, respectively) a new supercritical phase appears in the fluid that is distinct from the liquid or vapor phase. The solvent can then be removed without introducing a liquid-vapor interface, capillary forces, or any associated mass transfer limitations typically associated with receding liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In certain examples of the present disclosure, the use of near-critical conditions just below the critical point of the solvent system may allow production of aerogels or compositions with sufficiently low shrinkage, thus producing a commercially viable end-product.

Wet-gels can be dried using various techniques to provide aerogels. In some examples, wet-gel materials can be dried at ambient pressure, at subcritical conditions, or at supercritical conditions.

Both room temperature and high temperature processes can be used to dry gel materials at ambient pressure. In some examples, a slow ambient pressure drying process can be used in which the wet-gel is exposed to air in an open container for a period of time sufficient to remove solvent, e.g., for a period of time in the range of hours to weeks, depending on the solvent, the quantity of wet-gel, the exposed surface area, the size of the wet-gel, and the like.

In another example, the wet-gel material is dried by heating. For example, the wet-gel material can be heated in a convection oven for a period of time to evaporate most of the solvent (e.g., ethanol). After partially drying, the gel can be left at ambient temperature to dry completely for a period of time, e.g., from hours to days. This method of drying produces xerogels.

In some examples, the wet-gel material is dried by freeze drying. By “freeze drying” or “lyophilizing” is meant a low temperature process for removal of solvent that involves freezing a material (e.g., the wet-gel material), lowering the pressure, and then removing the frozen solvent by sublimation. As water represents an ideal solvent for removal by freeze drying, and water is the solvent in the method as disclosed herein, freeze drying is particularly suited for aerogel formation from the disclosed polyimide wet-gel materials. This method of drying produces cryogels, which may closely resemble aerogels.

Both supercritical and sub-critical drying can be used to dry wet-gel materials. In some examples, the wet-gel material is dried under subcritical or supercritical conditions. In an example of supercritical drying, the gel material can be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure. Generally, aerogels are obtained by this process.

In an example of subcritical drying, the gel material is dried using liquid CO₂ at a pressure in the range of about 800 psi to about 1200 psi at room temperature. This operation is quicker than supercritical drying; for example, the solvent (e.g., ethanol) can be extracted in about 15 minutes. Generally, aerogels are obtained by this process.

Several additional aerogel extraction techniques are known in the art, including a range of different approaches in the use of supercritical fluids in drying aerogels, as well as ambient drying techniques. For example, Kistler (J. Phys. Chem. (1932) 36: 52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically extracting the fluid from the sol-gel. U.S. Pat. No. 6,315,971 discloses a process for producing gel compositions comprising: drying a wet gel comprising gel solids and a drying agent to remove the drying agent under drying conditions sufficient to reduce shrinkage of the gel during drying. U.S. Pat. No. 5,420,168 describes a process whereby resorcinol/formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction. Other examples of extracting a liquid phase from aerogel materials can be found in U.S. Pat. Nos. 5,275,796 and 5,395,805.

In some examples, extracting the liquid phase from the wet-gel uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber. In other examples, extraction can be performed using any suitable mechanism, for example altering the pressures, timings, and solvent discussed above.

### Emulsion Method 2: Emulsifying the Gelation Mixture

In some examples, the method comprises forming an emulsion comprising the polyamic acid salt sol, immiscible solvent, a surfactant, and a gelation initiator which is a dehydrating agent, followed by mixing under high shear conditions. This method differs from that of emulsion method 1 described herein above only in that an emulsion of the aqueous polyamic acid salt and the water-immiscible solvent is formed following addition of the dehydrating agent rather than the addition of the dehydrating agent to a preformed emulsion as in method 1. This general non-limiting approach is illustrated in in FIG. 2. Each of the sol, the water-immiscible solvent, dehydrating agent, and the mixing conditions as well as the subsequent aging, washing, and drying stages are as described above with respect to emulsion method 1.

### Batch Methods of Forming Polyimide Beads

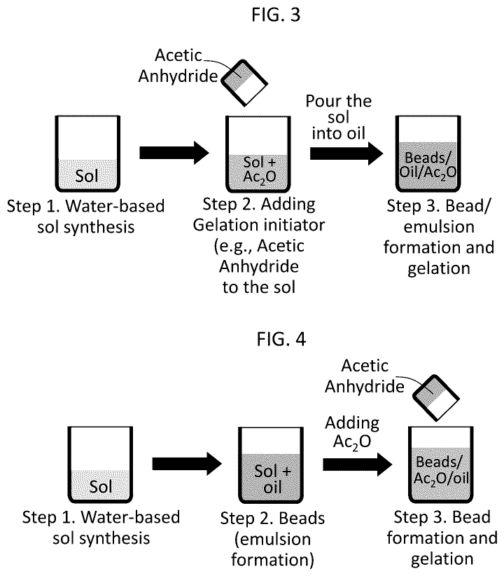

Conventional techniques for forming polyamic beads use a batch approach, in which the constituents for forming the emulsion are combined in a batch portion and a mixer is used to create shear for forming the emulsion. Batch size is limited by the speed of the mixer for creating the emulsion within the batch and by the rate of gelation after addition of the catalyst. The two methods for creating an emulsion described above (i.e., method 1: creating emulsion first and then adding catalyst, see FIG. 2 and FIG. 4; and method 2: forming a gelation mixture prior to adding the gelation mixture to the surfactant for forming beads, see FIG. 1 and FIG. 3) can be used to create the batch mixtures. For example, in the non-limiting batch processing route shown in FIG. 3, a gelation mixture is created by adding dehydrating agent (e.g., acetic anhydride) to an aqueous solution of polyamic acid salt; the gelation mixture is added to a sol-immiscible solvent; and a mixer is applied to create the beads. In the processing route shown in FIG. 4, the aqueous solution of polyamic acid salt is mixed with an immiscible (e.g., oil-based) solvent; the mixer is applied to form the emulsion and the dehydrating agent (e.g., acetic anhydride) is added to initiate gelation. In either processing route, the amount of bead formation is limited to the batch size. The batch size is determined by the mixer speed in relation to the amount of constituents it has to mix and to the rate of gelation.

The present technology does not include batch processing. Rather, the present technology is based on continuous or in-line processing routes. In the present technology, constituents as described herein (e.g., one or more of sol, immiscible solvent, surfactant, gelation initiator) are pumped to an in-line mixer and mixed while flowing through a processing system, thereby allowing the continually delivery of constituents to the in-line mixer. The present technology is advantageous not only due to an increase in production rates, but also in its ability to tailor the size and size distribution of the resulting beads through control over various processing parameters, such as mixing speed, rate of delivery of constituents, pressure within the in-line mixer, and recirculation or time spent within the in-line mixer.

The present technology can be applied to the two processing routes described above for batch mixtures. That is, the order of adding the gelation initiator either before or after the formation of the emulsion can be accounted for.

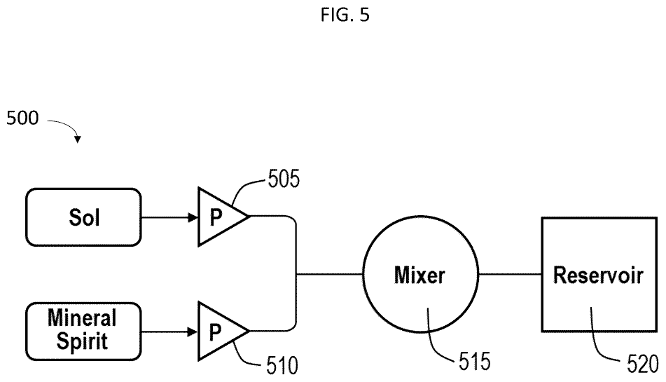

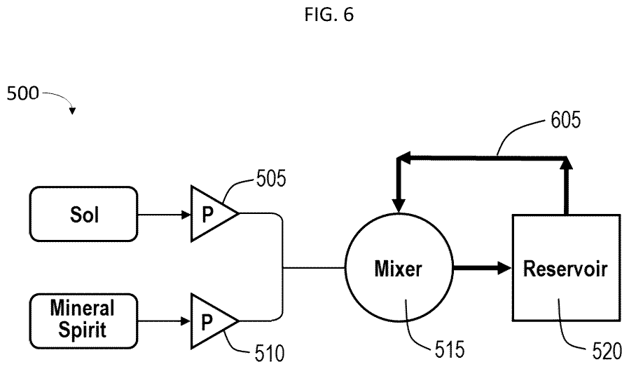

Referring to FIG. 5, shown is an in-line processing system for forming polymer beads, such as polyimide beads. In this processing system 500, a first pump 505 delivers a sol and a second pump 510 delivers the sol-immiscible solvent to an in-line mixer 515. The sol and s are mixed within a head of the in-line mixer to form an emulsion that is delivered to a reservoir 520 where the gelation initiator is added. In some examples, such as shown in FIG. 6, a recirculation loop 605 can be added between the reservoir 520 and the in-line mixer 515 to distribute the gelation initiator and/or to provide additional shear to the emulsion for control over the size of bead formation.

Pumps 505 and 510 can be any type of positive displacement pump that can deliver the sol and the immiscible solvent (optionally including a surfactant), respectively, to the mixer. In one example, pumps 505 and 510 are peristaltic pumps in which the rate of delivery of the sol and the immiscible solvent to the in-line mixer can be set and controlled. That is, the peristaltic pumps have a metering function or capability within the pump controller. As a result, a quantity of sol to immiscible solvent can be delivered to the head of the in-line mixer 515 for forming the emulsion.

In an example, in which the sol is a water-based sol and the immiscible solvent is oil-based, flow rates of the pump 505 and pump 510 can be controlled to deliver the fluids at a rate of 1:2 (sol: immiscible solvent). More particularly, in an example in which the sol is an aqueous solution including a polyamic acid salt and the immiscible solvent is mineral spirit, the flow rates on pump 505 and pump 510 delivered the fluids at a 1:2 ratio of sol to immiscible solvent to the head of the in-line mixer 515. In this example pump 505 and pump 510 are both peristaltic pumps.

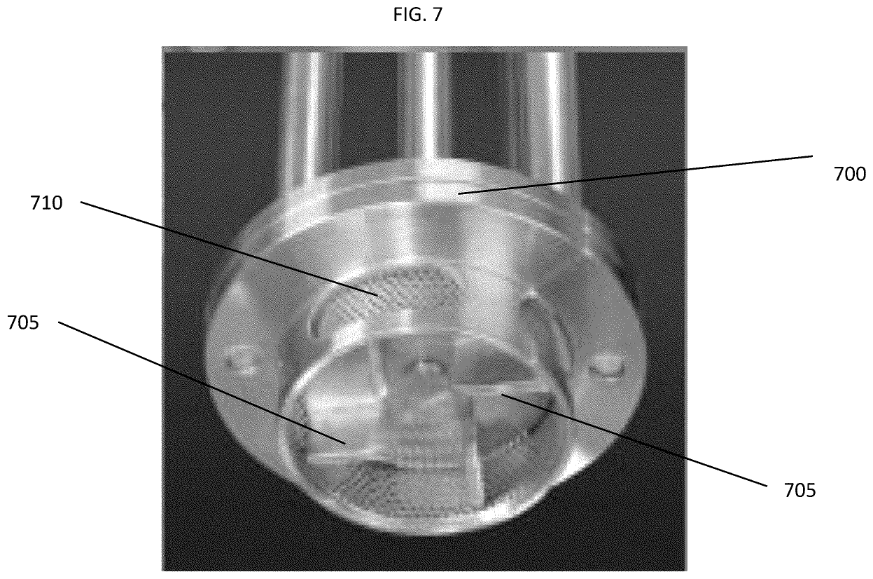

The sol and immiscible solvent are delivered to the in-line mixer 515. The in-line mixer 515 has a mixing head 700 shown in FIG. 7. The mixing head 700 includes a plurality of blade 705 which rotate to mix the sol and surfactant together. The mixing head 700 also includes a plurality of openings 710 which the mixed constituents (i.e., sol and immiscible solvent) and pass through to aerate/create an emulsion of the mixed constituents.

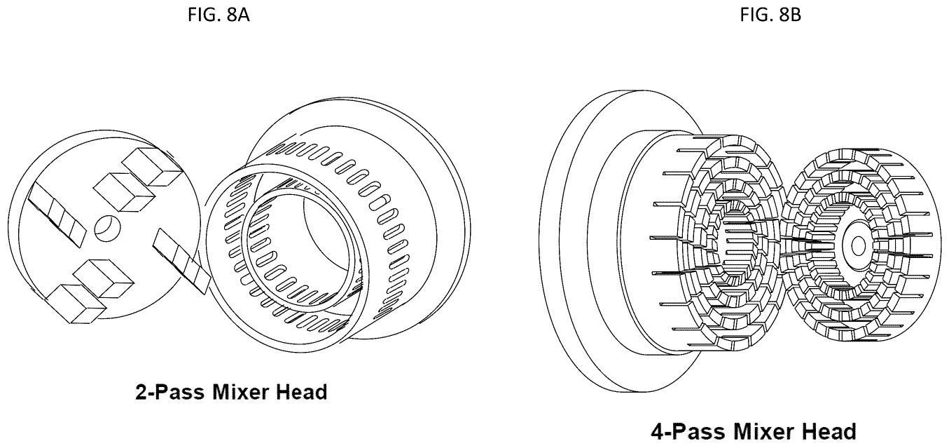

The mixing head 700 shown in FIG. 7 is a single pass mixing head. Other types of mixing heads can be utilized in the in-line mixer 515. For example, FIG. 8A depicts a two-pass mixing head in which the constituents to be mixed pass twice (i.e., have a longer residency time within the mixing head). FIG. 8B depicts yet another type of mixing head, a four-pass mixing head. Other mixing heads are also possible for use in the present technology.

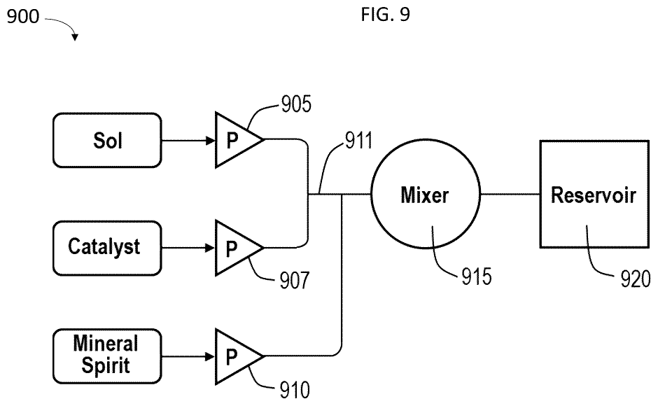

In the continuous mixing systems shown in FIG. 5 and FIG. 6, the gelation initiator (e.g., dehydrating agent such as acetic anhydride) for forming beads is added after the formation of the emulsion. That is, the gelation initiator is added after the sol and immiscible solvent are mixed in the in-line mixer. In the continuous mixing system shown in FIG. 9, the gelation initiator is added prior to the constituents being mixed into an emulsion.

Referring to FIG. 9, a continuous mixing system 900 includes three dedicated pumps for delivery of constituents to an in-line mixer 915. A first pump 905 pumps a sol solution; a second pump 907 delivers a gelation initiator, and a third pump 910 delivers a solvent (optionally including a surfactant) that is immiscible with the sol solution. The pump 907 can be positioned as shown in FIG. 9. That is, pump 907 and 905 can be connected such that the sol and gelation initiator are combined and delivered to a tubing location 911 prior to being combined with the solvent pumped by pump 910 (i.e., after T-junction but before in-line mixer 915). Alternatively, and not shown, each of pumps 905, 907, and 910 can deliver their respective constituent directly to the pump head for mixing.

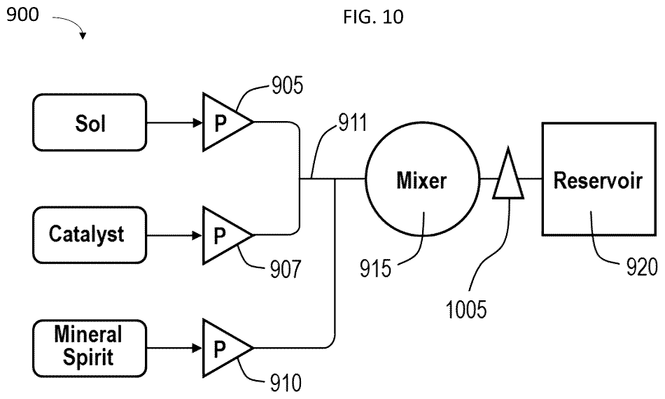

As described above, the in-line mixer can be any type of mixer (e.g., single pass, two-pass, four pass, etc.) that mixes the constituents together and creates an emulsion. Without wishing to be bound by theory, the amount of time that the constituents recirculate or resonate within the in-line mixer can have an effect on viscosity and/or final properties of the beads formed in the emulsion. As another possible way to control the amount of time within the in-line mixer, is by the addition of pressure controls. FIG. 10 depicts another possible example of a continuous mixing system 900. The mixing system of FIG. 10 includes a back pressure regulator valve 1005 positioned after the in-line mixer 915. By adjusting the back pressure regulator valve 1005, the pressure applied upstream (i.e., at the in-line mixer) can be controlled and as a result, the amount of time/mixing conditions can be altered.

The following examples illustrate various examples of the continuous mixing systems for forming an emulsion in accordance with the present technology. In addition, the following examples illustrate various methods for controlling resulting bead properties from an emulsion made with a continuous mixing system in accordance with the present technology.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed. No language in the specification should be construed as indicating any non-claimed element as essential to the practice of the disclosed materials and methods.

It will be readily apparent to one of ordinary skill in the relevant arts that suitable modifications and adaptations to the compositions, methods, and applications described herein can be made without departing from the scope of any examples or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein.

Although the technology herein has been described with reference to particular embodiments, it is to be understood that these embodiments are merely illustrative of the principles and applications of the present technology. It will be apparent to those skilled in the art that various modifications and variations can be made to the method and apparatus of the present technology without departing from the spirit and scope of the technology. Thus, it is intended that the present technology include modifications and variations that are within the scope of the appended claims and their equivalents.

Reference throughout this specification to “one embodiment,” “certain embodiments,” “one or more embodiments” or “an embodiment” means that a particular feature, structure, material, or characteristic described in connection with the embodiment is included in at least one embodiment of the technology. Thus, the appearances of phrases such as “in one or more embodiments,” “in certain embodiments,” “in one embodiment” or “in an embodiment” in various places throughout this specification are not necessarily referring to the same embodiment of the technology. Furthermore, the particular features, structures, materials, or characteristics may be combined in any suitable manner in one or more embodiments. Any ranges cited herein are inclusive.

Aspects of the present technology are more fully illustrated with reference to the following examples. Before describing several exemplary embodiments of the technology, it is to be understood that the technology is not limited to the details of construction or process steps set forth in the following description. The technology is capable of other embodiments and of being practiced or being carried out in various ways. The following examples are set forth to illustrate certain aspects of the present technology and are not to be construed as limiting thereof.

### EXAMPLES

The present technology may be further illustrated by the following non-limiting examples describing the methods.

### Example 1. Carbon Beads; In-Line Emulsification Using Pneumatic Pump and Post-Emulsification Gelation (PS-7)

Polyimide beads were prepared at a target density of 0.085 g/cc using an in-line emulsion method, and using the materials and amounts provided in Table 1. The polyimide beads were subsequently pyrolyzed to provide carbon beads to avoid charging events while imagining the beads in a scanning electron microscope (SEM).

TABLE 1
Polyimide bead materials and quantities

| Ingredient | Amount (grams) | Vol (mL) |
|---|---|---|
| p-Phenylenediamine (PDA) | 95 | |
| Water | 2348.5 | 2348.5 |
| Triethylamine (TEA) | 213.8 | 294.4 |
| Benzene-1,2,4,5-tetracarboxylic | 191.6 | |
| anhydride (PMDA) | | |
| Acetic anhydride | 385.7 | 357.1 |
| Total sol | 3020.8 | 3000 |
| Mineral Spirit | 6000 | |
| Surfactant (Hypermer A70) | 87.7 | |

A solution of p-phenylenediamine (PDA) was prepared by adding PDA (95 grams, 0.88 mol) to water (2348.5 mL) and stirred while heating. Once complete solution was obtained (approximately 8 minutes), the solution was removed from the heat source and stirring was maintained. To the PDA solution was added benzene-1,2,4,5-tetracarboxylic anhydride (PMDA; 191.6 grams, 1:1 molar ratio with PDA) with stirring. The reaction mixture spontaneously generated heat. Once the solution of polyamic acid cooled to a temperature below about 80° F., triethylamine was added (294 ml, 2.40 molar ratio to PDA), followed by stirring for 4 hours to form the polyamic acid triethylammonium salt solution.

Meanwhile, a surfactant solution (Hypermer A70 in mineral spirits) was prepared. Hypermer A70 (87.7 g) was added to mineral spirits (6 kg) with vigorous stirring until complete dissolution was achieved.

The polyamic acid triethylammonium salt solution and the surfactant solution were independently supplied via pneumatic pumps (flow rates of 1.5 L/min for the polyamic acid triethylammonium salt solution and 3 L/min for the surfactant solution) to an in-line mixer operating at 2000 RPM to form an emulsion. The emulsion exited the in-line mixer into a reservoir. A non-limiting cartoon depiction of the component configuration for emulsification is provided in FIG. 6. Once the entirety of the emulsion was received into the reservoir, the emulsion was recirculated to the in-line mixer for 10 minutes to ensure complete emulsification.

Following complete emulsification, acetic anhydride (357.1 mL, 4.3 molar ratio to PMDA) was added to induce imidization, followed by stirring for 1 hour to complete imidization, forming a polyimide gel bead suspension. The bead suspension was allowed to stand at room temperature, during which time the beads settled at the bottom of the reservoir and the mineral spirits separated from the emulsion to form a top layer. The top mineral spirits layer was decanted as it formed. Following the decantation, ethanol (6 kg) was added to the remaining emulsion to assist with breaking the emulsion and removal of the mineral spirits from the beads. The ethanol-bead mixture was filtered through a Büchner funnel, and the collected bead cake was washed with ethanol (2×3 kg). The bead cake was dried in a convection oven at 70° C. for 5 hours. The dry beads were passed through a 350 μm sieve to remove any large agglomerates.

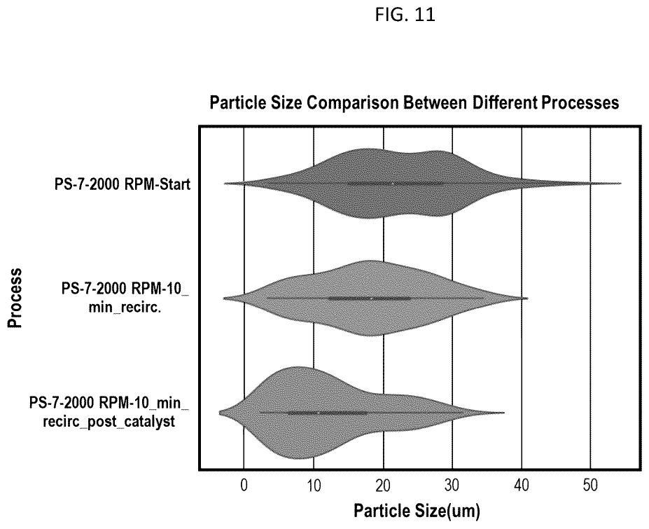

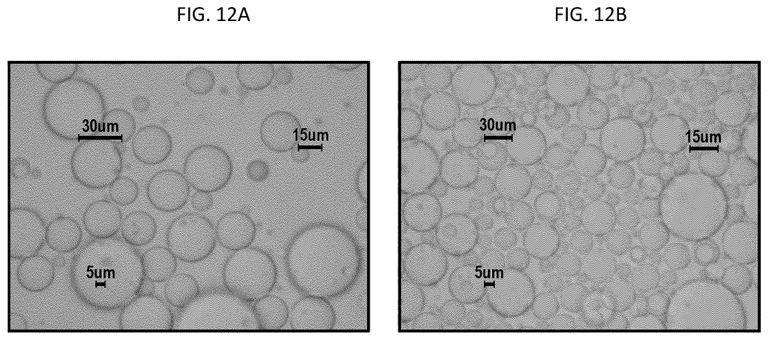

The mean particle size of the beads was about 10 to 15 μm. The particle size distribution for the emulsion particles after initial emulsification, after the recirculation, and after imidization (gelation with acetic anhydride) is provided in FIG. 11, and SEM photomicrographs of particles after the recirculation and after imidization are provided in FIGS. 12A and 12B, respectively.

The sieved beads were transferred to ceramic crucibles and pyrolyzed for 2 hours at 1050° C. under nitrogen to provide the corresponding carbon beads (104.6 g).

### Example 2. Carbon Beads; In-Line Emulsification Using Peristaltic Pump and Post-Emulsification Gelation; 7 Minute Recirculation (PS-8)

Polyimide beads were prepared and pyrolyzed as in Example 1, except that the pneumatic pumps were replaced with peristaltic pumps to provide more accurate control of flow rates. The flow rates were 1050 mL/min for the polyamic acid triethylammonium salt solution and 2100 mL/min for the surfactant solution. The recirculation time was reduced to 7 minutes, and the mixer speed was increased to 2500 rpm.

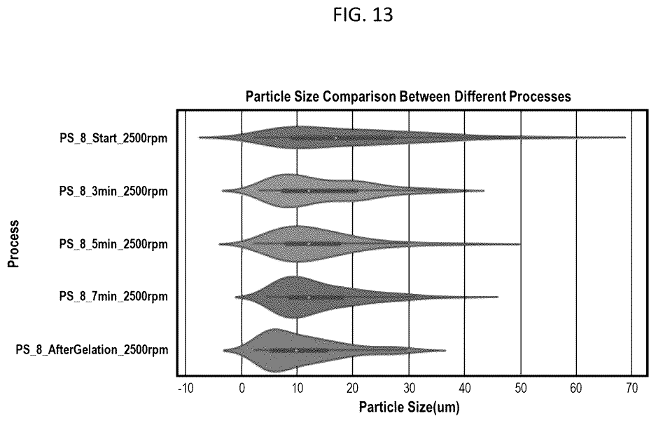

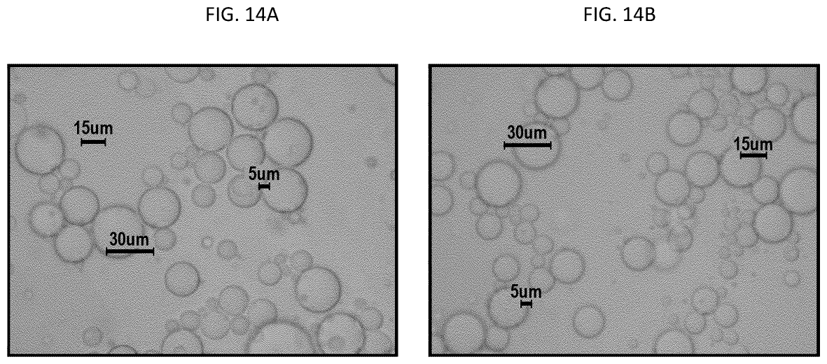

The yield was identical to that for the beads of Example 1. The particle size distribution for the emulsion particles after initial emulsification, after various recirculation time points (3, 5, and 7 minutes), and after imidization (gelation with acetic anhydride) is provided in FIG. 13, and SEM photomicrographs of particles after the recirculation and after imidization are provided in FIGS. 14A and 14B, respectively, which demonstrate that the particle size distribution and mean particle sizes were comparable to those in Example 1.

The sieved beads were transferred to ceramic crucibles and pyrolyzed for 2 hours at 1050° C. under nitrogen to provide carbon beads (104.6 g).

### Example 3. Carbon Beads; In-Line Emulsification Using Peristaltic Pump and Post-Emulsification Gelation; 5 Minute Recirculation (PS-9/10)

Polyimide beads were prepared and pyrolyzed as in Example 2, except that the preparation was performed at twice the scale of Example 2, and the recirculation time was reduced to 5 minutes.

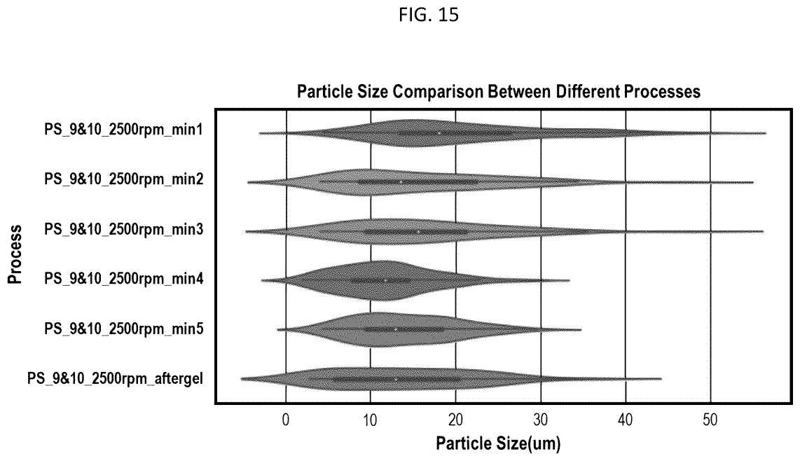

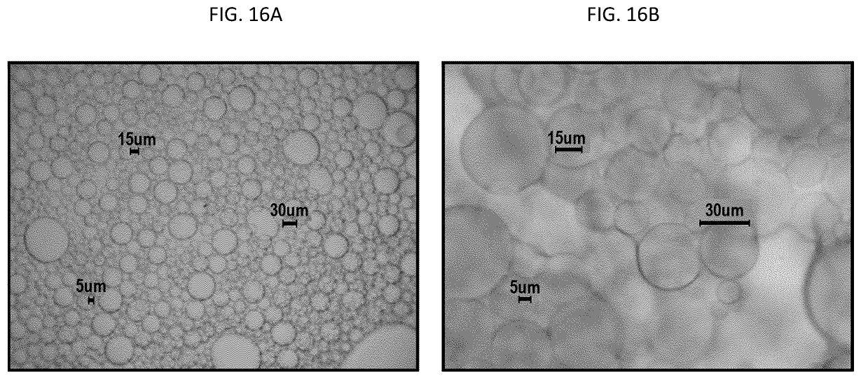

The particle size distribution for the emulsion particles after initial emulsification, after various recirculation time points (1, 2, 3, 4, and 5 minutes), and after imidization (gelation with acetic anhydride) is provided in FIG. 15, and SEM photomicrographs of particles after 3 minutes of recirculation and after imidization are provided in FIGS. 16A and 16B, respectively, which demonstrate that the mean particle size (10 to 15 μm) was comparable to that in Example 2, but the particle size distribution was wider.

The sieved beads were transferred to ceramic crucibles and pyrolyzed for 2 hours at 1050° C. under nitrogen to provide carbon beads.

### Example 4. Carbon Beads; In-Line Emulsification Using Peristaltic Pump and Post-Emulsification Gelation; Back Pressure (PS-11/12)

Polyimide beads were prepared and pyrolyzed as in Example 3, except that back pressure was applied, with a concomitant reduction in flow rate (450 mL/min for the polyamic acid triethylammonium salt solution and 900 mL/min for the surfactant solution). The back pressure was applied by installing a valve between the mixer and the reservoir, and partially closing the valve to restrict flow. See illustration of system as provided in FIG. 10.

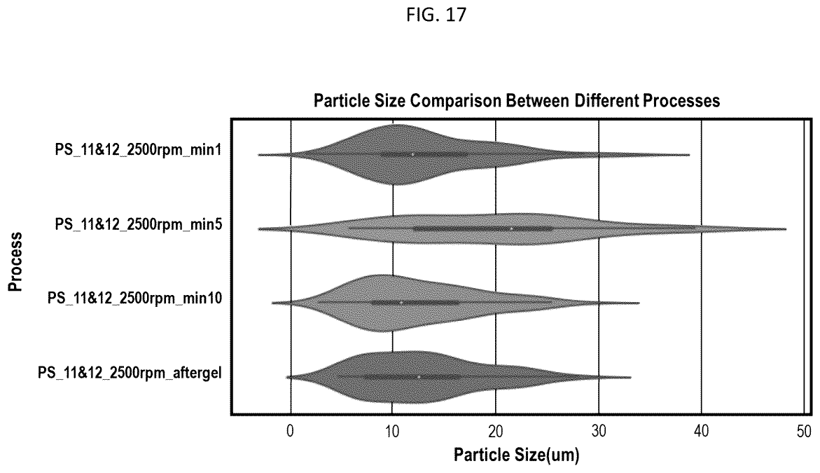

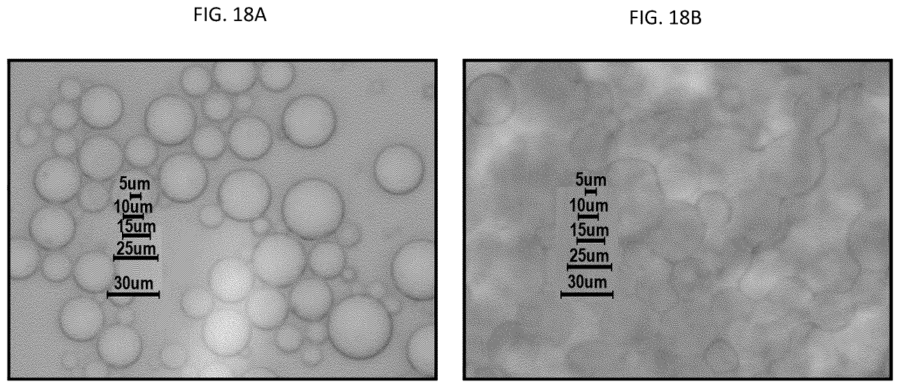

The particle size distribution for the emulsion particles at various time points after passage through the mixer (1, 5, and 10 minutes), and after imidization (gelation with acetic anhydride) is provided in FIG. 17, and SEM photomicrographs of particles 3 minutes after emulsification and after imidization are provided in FIGS. 18A and 18B, respectively, which demonstrate that the mean particle size (11 to 13 μm) was comparable to that in Example 3, but the particle size distribution was more narrow.

The sieved beads were transferred to ceramic crucibles and pyrolyzed for 2 hours at 1050° C. under nitrogen to provide carbon beads.

### Example 5. Carbon Beads; In-Line Emulsification Using Peristaltic Pump and Post-Emulsification Gelation; Back Pressure (PS-13/14)

Polyimide beads were prepared and pyrolyzed as in Example 4, except that the flow rate was further reduced (400 mL/min for the polyamic acid triethylammonium salt solution and 800 mL/min for the surfactant solution).

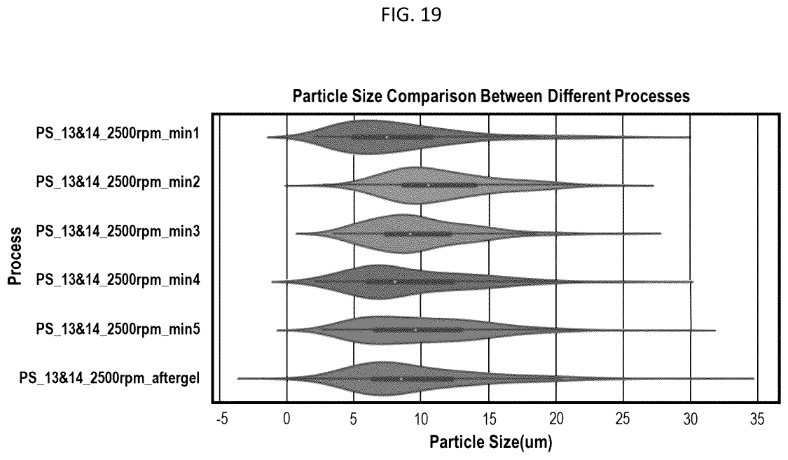

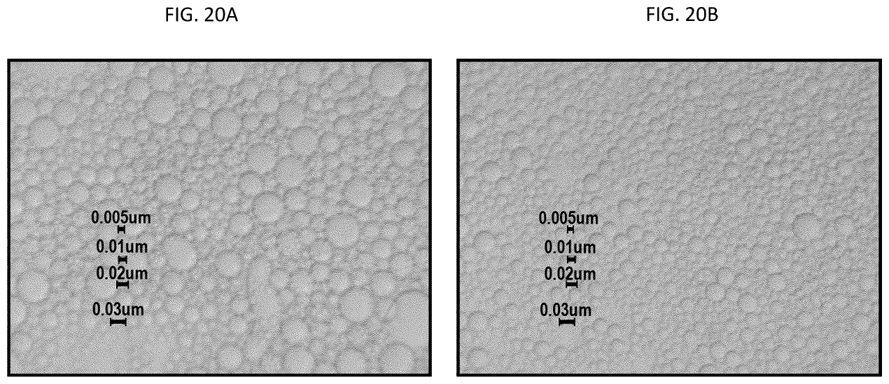

The particle size distribution for the emulsion particles at various time points after passage through the mixer (1, 3, 5, 7, and 12 minutes), and after imidization (gelation with acetic anhydride) is provided in FIG. 19, and SEM photomicrographs of particles 5 minutes after emulsification and after imidization are provided in FIGS. 20A and 20B, respectively, which demonstrate that the mean particle size (7 to 8 μm) was smaller than that in Example 4, and the particle size distribution was even more narrow.

The sieved beads were transferred to ceramic crucibles and pyrolyzed for 2 hours at 1050° C. under nitrogen to provide carbon beads.

### Example 6. Carbon Beads; In-Line Emulsification Using Peristaltic Pump and Pre-Emulsification Gelation; Back Pressure; No Recirculation (PS-15)

Polyimide beads were prepared at a target density of 0.085 g/cc using an in-line emulsion method. The polyimide beads were subsequently pyrolyzed to provide carbon beads.

A solution of p-phenylenediamine (PDA) was prepared by adding PDA (190 grams, 1.76 mol) to water (4697 mL) and stirred while heating. Once complete solution was obtained (approximately 8 minutes), the solution was removed from the heat source and stirring was maintained. To the PDA solution was added benzene-1,2,4,5-tetracarboxylic anhydride (PMDA; 383.2 grams, 1:1 molar ratio with PDA) with stirring. The reaction mixture spontaneously generated heat. Once the solution of polyamic acid cooled to a temperature below about 80° F., triethylamine was added (588 ml, 2.40 molar ratio to PDA), followed by stirring for 4 hours to form the polyamic acid triethylammonium salt solution.

Meanwhile, a surfactant solution (Hypermer A70 in mineral spirits) was prepared. Hypermer A70 (175.4 g) was added to mineral spirits (12 kg) with vigorous stirring until complete dissolution was achieved. The flow rates were calculated based on the volumetric mix ratio for the different components, the sol flow rate was set at 300 (ml/min), miner spirit flow rate was set at 600 (ml/min) and the catalyst flow rate was set at 41 (ml/min). The speed of the in-line shear mixer was set at 3000 rpm to achieve optimum particle size in the range of 5-10 micrometers.

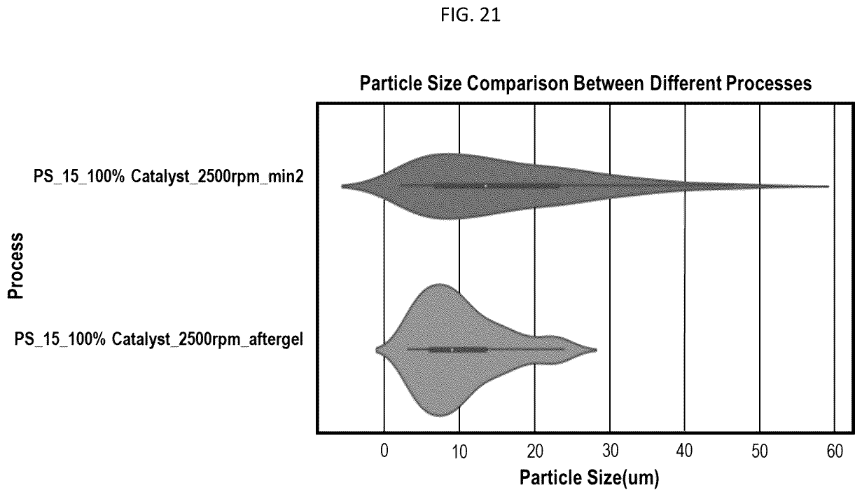

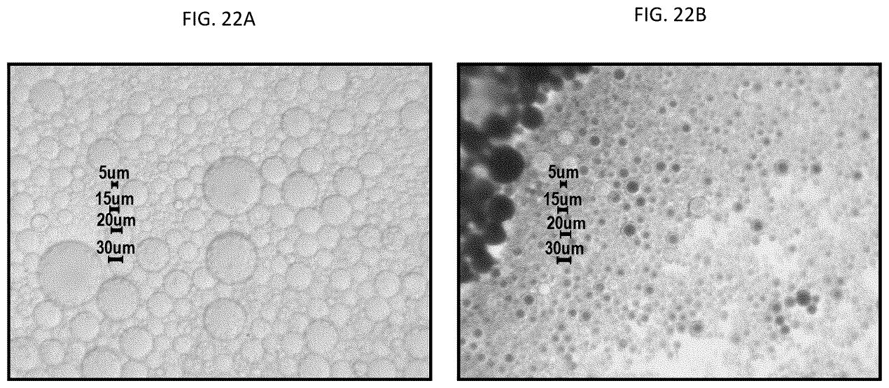

The particle size distribution for the emulsion particles at various time points after passage through the mixer (2 minutes), and after imidization (gelation with acetic anhydride) is provided in FIG. 21, and SEM photomicrographs of particles 2 minutes after emulsification and after imidization are provided in FIGS. 22A and 22B, respectively, which demonstrate that the mean particle size (7 to 8 μm) was smaller than that in Example 4, and the particle size distribution was even more narrow.

The sieved beads were transferred to ceramic crucibles and pyrolyzed for 2 hours at 1050° C. under nitrogen to provide carbon beads for imaging.

### Example 7. Carbon Beads; In-Line Emulsification Using Peristaltic Pump and Pre-Emulsification Gelation (PS-19)

Polyimide beads were prepared at a target density of 0.085 g/cc using an in-line emulsion method. The polyimide beads were subsequently pyrolyzed to provide carbon beads.

A solution of p-phenylenediamine (PDA) was prepared by adding PDA (190 grams, 1.76 mol) to water (4697 mL) and stirred while heating. Once complete solution was obtained (approximately 8 minutes), the solution was removed from the heat source and stirring was maintained. To the PDA solution was added benzene-1,2,4,5-tetracarboxylic anhydride (PMDA; 383.2 grams, 1:1 molar ratio with PDA) with stirring. The reaction mixture spontaneously generated heat. Once the solution of polyamic acid cooled to a temperature below about 80° F., triethylamine was added (588 ml, 2.40 molar ratio to PDA), followed by stirring for 4 hours to form the polyamic acid triethylammonium salt solution.

Meanwhile, a surfactant solution (Hypermer A70 in mineral spirits) was prepared. Hypermer A70 (175.4 g) was added to mineral spirits (12 kg) with vigorous stirring until complete dissolution was achieved.

Two peristaltic pumps were configured to independently provide the polyamic acid triethylammonium salt solution (600 mL per minute feed rate) and the surfactant solution (300 mL per minute feed rate) to an in-line mixer operating at 2800 RPM. A third peristaltic pump was configured to independently provide acetic anhydride (357.1 mL) to the sol/surfactant stream prior to entering the mixer. The gelling emulsion exited the in-line mixer into a reservoir, such as reservoir 920. A non-limiting cartoon depiction of the component configuration for emulsification is provided in FIG. 9. The bead suspension was filtered, washed, and dried as described in Example 1. The final weight of the bead batch was 819 g after sieving (92.7% yield). BET measurements on the bead batch conducted with a Micromeritics Instrument (TriStar II 3020) measured a BET surface area of 84.4194 m²/g. The particle size for the bead batch was analyzed and determined to have a median size of 24.69886 microns, a mean size of 30.19683 microns, a standard deviation of 19.6008 microns, a geometric mean size of 25.4780 microns, a geometric standard deviation of 1.7772 microns, and a mode size of 21.3997 microns.

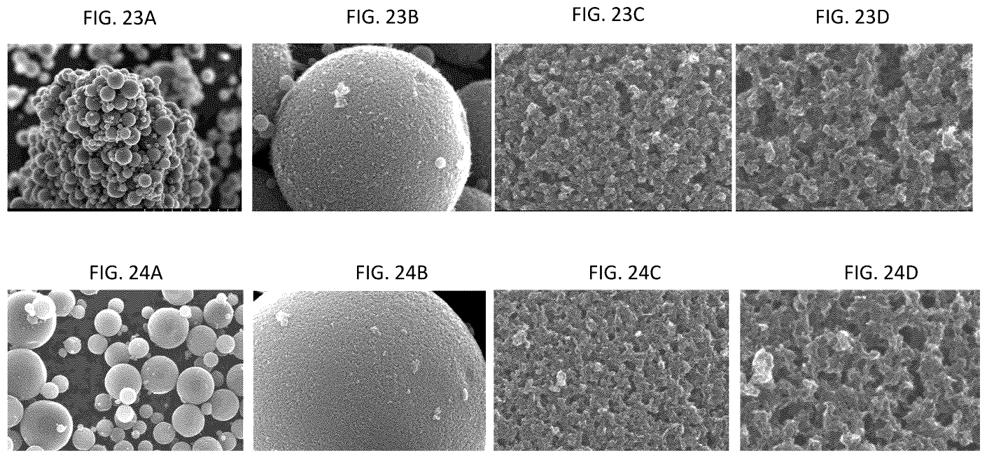

To compare morphology between beads made using the continuous method of Example 7 of the present disclosure and beads made using conventional benchtop methods (reference), a water-based bench top formulation was used to form aerogel beads. FIGS. 23A to 23D are SEM images at different magnification providing the bead/aerogel morphology of the reference conventional benchtop (i.e, non-continuous) method. FIGS. 24A to 24D are SEM images at different magnification providing the bead/aerogel morphology of the materials formed using the inventive, continuous method provided in Example 7. As is evident from viewing FIGS. 23A-23D versus FIGS. 24A-24D, there is minimal if any difference in particle morphology between the conventional benchtop method and the inventive method of the present disclosure.

In this application, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative aspects of the disclosure will be apparent to those skilled in the art in view of this description. Accordingly, this description is to be construed as illustrative only and is for the purpose of teaching those skilled in the art the general manner of carrying out the present technology. It is to be understood that the forms of the technology shown and described herein are to be taken as examples. Elements and materials may be substituted for those illustrated and described herein, parts and processes may be reversed, and certain features of the technology may be utilized independently, all as would be apparent to one skilled in the art after having the benefit of this description of the technology. Changes may be made in the elements described herein without departing from the spirit and scope of the technology as described in the following claims.

When used in this specification and claims, the terms “comprises” and “comprising” and variations thereof mean that the specified features, steps or integers are included. The terms are not to be interpreted to exclude the presence of other features, steps or components. The technology comprises, consists of or consists essentially of the disclosed and claimed features.

The technology may also broadly consist in the parts, elements, steps, examples and/or features referred to or indicated in the specification individually or collectively in any and all combinations of two or more said parts, elements, steps, examples and/or features. In particular, one or more features in any of the embodiments, examples and aspects described herein may be combined with one or more features from any other embodiments, examples and aspects described herein.

Protection may be sought for any features disclosed in any one or more published documents referenced herein in combination with the present disclosure.

Although certain example embodiments of the disclosure have been described, the scope of the appended claims is not intended to be limited solely to these embodiments. The claims are to be construed literally, purposively, and/or to encompass equivalents.

What is claimed is:

1. A method for in-line manufacturing of an emulsion for polymer bead formation, the method comprising:
pumping with a first pump a sol to an in-line mixer;
pumping with a second pump a solvent to the in-line mixer, wherein the solvent is immiscible with the sol, the solvent optionally comprising a surfactant;
mixing the sol and the solvent to form the emulsion;
providing a gelation initiator to a mixing system downstream of the first pump and the second pump to disperse the gelation initiator throughout the emulsion; and
transporting the emulsion with gelation initiator dispersed therethrough to a processing station located downstream of the mixing system.

2. The method of claim 1, wherein the mixing system comprises the in-line mixer and a reservoir.

3. The method of claim 1 wherein the gelation initiator is provided to the reservoir of the mixing system.

4. The method of claim 1, wherein the mixing system includes a recirculation loop between the reservoir and the in-line mixer.

5. The method of claim 1, wherein the mixing system includes a controller and a particle size sensor in connection with the recirculation loop for controlling a number of recirculation passes between the reservoir and the in-line mixer.

6. The method of claim 1, wherein the gelation initiator is provided to the in-line mixer.

7. The method of claim 1, wherein the mixing system comprises a second mixer downstream from the in-line mixer.

8. The method of claim 1, wherein the solvent is an organic solvent, optionally wherein the organic solvent is mineral spirits.

9. The method of claim 1, wherein the sol is aqueous.

10. The method of claim 9, wherein pumping the solvent to the in-line mixer occurs at a flow rate of 2:1 as compared to the aqueous sol.

11. The method of claim 1, further comprising controlling pressure during the step of mixing the sol and the solvent to form the emulsion, the pressure being controlled to create a predetermined residence time in the in-line mixer for particle size selection.

12. The method of claim 1, wherein the gelation initiator is provided to the reservoir of the mixing system.

13. The method of claim 1 claim, wherein the gelation initiator is provided to the in-line mixer.

14. The method of claim 1, wherein a back pressure regulator is positioned between the in-line mixer and the processing station for controlling the pressure.

15. The method of claim 1, wherein the in-line mixer comprises a two-pass mixer head or a four-pass mixer head.

16. A method for in-line manufacturing of an emulsion for polymer bead formation, the method comprising:
pumping with a first pump a sol to an in-line mixer;
pumping with a second pump a solvent to the in-line mixer, wherein the solvent is immiscible with the sol, the solvent optionally comprising a surfactant;
providing a gelation initiator for the sol to the in-line mixer;
mixing the sol, the solvent and the gelation initiator in the in-line mixer to form the emulsion with dispersed gelation initiator therethrough; and
transporting the emulsion with dispersed gelation initiator therethrough to a downstream processing station.

17. The method of claim 16, further comprising controlling pressure during mixing the sol, the solvent and the gelation initiator to create a predetermined residence time in the in-line mixer for control over particle size.

18. The method of claim 16, wherein a back pressure regulator is positioned between the in-line mixer and the downstream processing station, and wherein the back pressure regulator is adjusted to control particle size.

19. The method of claim 16, wherein the solvent is an organic solvent, optionally wherein the organic solvent is mineral spirit.

20. The method of claim 16, wherein the sol is aqueous, and pumping the solvent to the in-line mixer occurs at a flow rate of 2:1 as compared to the aqueous sol.

21. The method of claim 16, further comprising controlling viscosity of the emulsion with dispersed gelation initiator therethrough.

22. A method for continuous processing of an emulsion-based polymer product, the method comprising:
delivering to an in-line mixer a solvent through a pumping system, wherein the solvent is immiscible with the sol, the solvent optionally comprising a surfactant;
delivering to the in-line mixer a mixed fluid including a sol pumped using a dedicated first pump and a gelation initiator solution pumped using a dedicated second pump;
mixing the mixed fluid together with the solvent in the in-line mixer to form an emulsion; and
transporting the emulsion to a downstream processing station.
